(19) United States
(12) Patent Application Publication
(10) Pub. No.: US 2026/0255240 A1
(43) Pub. Date: Aug. 27, 2026

(54) CELL SELECTION AND RESELECTION

(71) Applicant: Nokia Technologies Oy, Espoo (FI)

(72) Inventors: Jussi-Pekka KOSKINEN, Oulu (FI); Samuli Heikki TURTINEN, Oulu (FI)

(21) Appl. No.: 18/995,442

(22) PCT Filed: Jun. 20, 2023
(86) PCT No.: PCT/EP2023/066541

§ 371 Date: Jan. 16, 2025

(30) Foreign Application Priority Data
Aug. 16, 2022 (FI) 20225729

(51) Int. Cl. H04W 36/08; H04W 36/00

(52) U.S. Cl. CPC H04W 36/08; H04W 36/0072; H04W 36/008355

(57) ABSTRACT

Embodiments of the present disclosure relate to cell selection and reselection. A terminal device may receive system information of a first cell from a network device in a radio network, wherein the system information provides one or more frequencies that a terminal device of a defined type is allowed to access. The terminal device may determine, based on at least the system information, to select or re-select a second cell within the radio network whose frequency belongs to the provided one or more frequencies or to select or reselect a third cell within the radio network whose frequency does not belong to the provided one or more frequencies. In this way, cell selection and reselection for the terminal device of the defined type may be improved.

### FIELD

Various example embodiments relate to the field of telecommunication and in particular, to a method, device, apparatus and computer readable storage medium for cell selection and reselection schemes.

### BACKGROUND

Research has been conducted by 3GPP on Reduced Capability (RedCap) terminal devices to improve the RedCap terminal devices in terms of complexity reduction, coverage recovery, and terminal power savings. Better solutions are needed for cell selection and reselection of RedCap terminal devices as well as other similar terminal devices.

### SUMMARY

In general, example embodiments of the present disclosure provide a solution for performing cell selection and/or cell reselection of a terminal device in a radio network.

In a first aspect, there is provided a terminal device. The terminal device may include at least one processor and at least one memory storing instructions. When executed by the at least one processor, the instructions cause the terminal device at least to receive system information of a first cell from a network device in a radio network, wherein the system information provides one or more frequencies that a terminal device of a defined type is allowed to access; and determine, based on at least the system information, to select or re-select a second cell within the radio network whose frequency belongs to the provided one or more frequencies or to select or re-select a third cell within the radio network whose frequency does not belong to the provided one or more frequencies.

In a second aspect, there is provided a network device. The network device may include at least one processor and at least one memory storing instructions. When executed by the at least one processor, the instructions cause the network device at least to transmit, to a terminal device, system information of a first cell within a radio network, wherein the system information of the first cell provides one or more frequencies that a terminal device of a defined type is allowed to access in order for the terminal device to determine to select or re-select a second cell within the radio network whose frequency belongs to the provided one or more frequencies or to select or re-select a third cell within the radio network whose frequency does not belong to the provided one or more frequencies.

In a third aspect, there is provided a method. The method may include receiving, at a terminal device, system information of a first cell from a network device in a radio network, wherein the system information provides one or more frequencies that a terminal device of a defined type is allowed to access; and determining, based on at least the system information, to select or re-select a second cell within the radio network whose frequency belongs to the provided one or more frequencies or to select or re-select a third cell within the radio network whose frequency does not belong to the provided one or more frequencies.

In a fourth aspect, there is provided a method. The method may include transmitting, at a network device to a terminal device, system information of a first cell within a radio network, wherein the system information of the first cell provides one or more frequencies that a terminal device of a defined type is allowed to access in order for the terminal device to determine to select or re-select a second cell within the radio network whose frequency belongs to the provided one or more frequencies or to select or re-select a third cell within the radio network whose frequency does not belong to the provided one or more frequencies.

In a fifth aspect, there is provided an apparatus. The apparatus may include means for receiving, at a terminal device, system information of a first cell from a network device in a radio network, wherein the system information provides one or more frequencies that a terminal device of a defined type is allowed to access; and means for determining, based on at least the system information, to select or re-select a second cell within the radio network whose frequency belongs to the provided one or more frequencies or to select or re-select a third cell within the radio network whose frequency does not belong to the provided one or more frequencies.

In a sixth aspect, there is provided an apparatus. The apparatus may include means for transmitting, at a network device to a terminal device, system information of a first cell within a radio network, wherein the system information of the first cell provides one or more frequencies that a terminal device of a defined type is allowed to access in order for the terminal device to determine to select or re-select a second cell within the radio network whose frequency belongs to the provided one or more frequencies or to select or re-select a third cell within the radio network whose frequency does not belong to the provided one or more frequencies.

In a seventh aspect, there is provided a computer program. The computer program may include instructions. When executed by an apparatus, the instructions cause the apparatus at least to perform the method of the third aspect.

In an eighth aspect, there is provided a computer program. The computer program may include instructions. When executed by an apparatus, the instructions cause the apparatus at least to perform the method of the fourth aspect.

In a ninth aspect, there is provided a computer readable medium. The computer readable medium may include program instructions that, when executed by an apparatus, cause the apparatus to perform at least the method according to any one of the above third or fourth aspect.

In a tenth aspect, there is provided a terminal device. The terminal device may include receiving circuitry configured to receive system information of a first cell from a network device in a radio network, wherein the system information provides one or more frequencies that a terminal device of a defined type is allowed to access; and determining circuitry configured to determine, based on at least the system information, to select or re-select a second cell within the radio network whose frequency belongs to the provided one or more frequencies or to select or re-select a third cell within the radio network whose frequency does not belong to the provided one or more frequencies.

In an eleventh aspect, there is provided a network device. The network device may include transmitting circuitry configured to transmit, to a terminal device, system information of a first cell within a radio network, wherein the system information of the first cell provides one or more frequencies that a terminal device of a defined type is allowed to access in order for the terminal device to determine to select or re-select a second cell within the radio network whose frequency belongs to the provided one or more frequencies or to select or re-select a third cell within the radio network whose frequency does not belong to the provided one or more frequencies.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example scenario of cell selection and/or cell reselection of a terminal device in which embodiments of the present disclosure may be implemented;

FIG. 3 illustrates a signaling flow for communications according to some embodiments of the present disclosure;

FIG. 4 illustrates a flowchart of a method implemented at a terminal device according to some other embodiments of the present disclosure;

FIG. 5 illustrates a flowchart of a method implemented at a network device according to some embodiments of the present disclosure;

FIG. 6 illustrates a simplified block diagram of an apparatus that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The usage scenarios that have been identified for 5G are enhanced mobile broadband (eMBB), massive machine-type communication (mMTC), and Ultra-Reliable and Low Latency communication (URLLC). Yet another identified area is time sensitive communication (TSC). In particular, mMTC, URLLC and TSC are associated with novel IoT use cases that are targeted in vertical industries. It is envisaged that eMBB, mMTC, URLLC and TSC use cases may all need to be supported in the same network.

In the 3GPP study on “self-evaluation towards IMT-2020 submission” it was confirmed that NB-IOT and LTE-MTC (also known as eMTC) fulfil the IMT-2020 requirements for mMTC and can be certified as 5G technologies. For URLLC support, URLLC features were introduced in Release 15 for both LTE and NR, and NR URLLC is further enhanced in Release 16 within the enhanced URLLC (eURLLC) and Industrial IoT work items. Rel-16 also introduced support for Time-Sensitive Networking (TSN) and 5G integration for TSC use cases.

Beside the use cases that are already adequately addressed by the mentioned technologies, the following categories of mid-range use cases have been identified where some NR enhancements may be motivated.

One important objective of 5G is to enable connected industries. 5G connectivity can serve as catalyst for next wave of industrial transformation and digitalization, which improve flexibility, enhance productivity and efficiency, reduce maintenance cost, and improve operational safety. Devices in such environment include e.g. pressure sensors, humidity sensors, thermometers, motion sensors, accelerometers, actuators, etc. It is desirable to connect these sensors and actuators to 5G radio access and core networks. The massive industrial wireless sensor network (IWSN) use cases and requirements described in TR 22.804, TS 22.104, TR 22.832 and TS 22.261 include not only URLLC services with very high requirements, but also relatively low-end services with the requirement of small device form factors, and/or being completely wireless with a battery life of several years. The requirements for these services are higher than LPWA (i.e. LTE-MTC/NB-IOT) but lower than URLLC and eMBB.

Similar to connected industries, 5G connectivity can serve as catalyst for the next wave smart city innovations. As an example, TR 22.804 describes smart city use case and requirements for that. The smart city vertical covers data collection and processing to more efficiently monitor and control city resources, and to provide services to city residents. Especially, the deployment of surveillance cameras is an essential part of the smart city but also of factories and industries.

Finally, wearables use case includes smart watches, eHealth related devices, personal protection equipment (PPE), and medical monitoring devices for use in public safety applications, etc. One characteristic for the use case is that the device is small in size.

As a baseline, requirements for these three use cases including generic requirements in terms of device complexity, device size and deployment scenarios and use case specific requirements in terms of industrial wireless sensors, video surveillance and wearables are as below.

In terms of device complexity, the main motivation for the new device type is to lower the device cost and complexity as compared to high-end eMBB and URLLC devices of Rel-15/Rel-16. This is especially the case for industrial sensors.

In terms of device size, a requirement for most use cases is that the standard enables a device design with compact form factor.

In terms of deployment scenarios, the system should support all FR1/FR2 bands for FDD and TDD.

In terms of industrial wireless sensors, reference use cases and requirements are described in TR 22.832 and TS 22.104: Communication service availability is 99.99% and end-to-end latency less than 100 ms. The reference bit rate is less than 2 Mbps (potentially asymmetric e.g. UL heavy traffic) for all use cases and the device is stationary. The battery should last at least few years. For safety related sensors, latency requirement is lower, 5-10 ms (TR 22.804).

In terms of video surveillance, as described in TR 22.804, reference economic video bitrate would be 2-4 Mbps, latency <500 ms, reliability 99%-99.9%. High-end video e.g. for farming would require 7.5-25 Mbps. It is noted that traffic pattern is dominated by UL transmissions.

In terms of wearables, reference bitrate for smart wearable application can be 5-50 Mbps in DL and 2-5 Mbps in UL, and peak bit rate of the device can be higher, up to 150 Mbps for downlink and up to 50 Mbps for uplink. Battery of the device should last multiple days (up to 1-2 weeks).

Techniques for UE complexity reduction, coverage recovery and UE power saving for these use cases have been studied in the RedCap study item documented in TR 38.875. The intention with this work item is to specify a UE feature and parameter list with lower end capabilities, relative to Release 16 eMBB and URLLC NR to serve the three use cases mentioned above.

This work item has the following objectives:
I) Specify support for the following UE complexity reduction features [RAN1, RAN2, RAN4]:
   a) Reduced maximum UE bandwidth:
      i. Maximum bandwidth of an FR1 RedCap UE during and after initial access is 20 MHz.
      ii. Maximum bandwidth of an FR2 RedCap UE during and after initial access is 100 MHz.
   b) Reduced minimum number of Rx branches:
      i. For frequency bands where a legacy NR UE is required to be equipped with a minimum of 2 Rx antenna ports, the minimum number of Rx branches supported by specification for a RedCap UE is 1. The specification also supports 2 Rx branches for a RedCap UE in these bands.
      ii. For frequency bands where a legacy NR UE (other than 2-Rx vehicular UE) is required to be equipped with a minimum of 4 Rx antenna ports, the minimum number of Rx branches supported by specification for a RedCap UE is 1. The specification also supports 2 Rx branches for a RedCap UE in these bands.
      iii. A means shall be specified by which the gNB can know the number of Rx branches of the UE.
   c) Maximum number of DL MIMO layers:
      i. For a RedCap UE with 1 Rx branch, 1 DL MIMO layer is supported.
      ii For a RedCap UE with 2 Rx branches, 2 DL MIMO layers are supported.
   d) Relaxed maximum modulation order:
      i. Support of 256QAM in DL is optional (instead of mandatory) for an FR1 RedCap UE.
      ii. No other relaxations of maximum modulation order are specified for a RedCap UE.
   e) Duplex operation:
      i. HD-FDD type A with the minimum specification impact (Note that FD-FDD and TDD are also supported.)
II) Specify definition of one RedCap UE type including capabilities for RedCap UE identification and for constraining the use of those RedCap capabilities only for RedCap UEs, and preventing RedCap UEs from using capabilities not intended for RedCap UEs including at least carrier aggregation, dual connectivity and wider bandwidths. [RAN2, RAN1]
   a) The existing UE capability framework is used; changes to capability signalling are specified only if necessary.
III) Specify functionality that will enable RedCap UEs to be explicitly identifiable to networks through an early indication in Msg1 and/or Msg3, and Msg A if supported, including the ability for the early indication to be configurable by the network. [RAN2, RAN1]
IV) Specify a system information indication to indicate whether a RedCap UE can camp on the cell/frequency or not; it shall be possible for the indication to be specific to the number of Rx branches of the UE. [RAN2, RAN1]
V) Specify necessary updates of UE capabilities (38.306) and RRC parameters (38.331). [RAN2]
VI) Specify support for the following Extended DRX enhancements for RedCap UEs [RAN2, RAN3, RAN4]:
   a) Extended DRX for RRC Inactive and Idle with eDRX cycles up to 10.24 s, without using PTW and PH, and with common design (e.g. common set of eDRX values) between RRC Inactive and Idle.
   b) Extended DRX for RRC Inactive and Idle with eDRX cycles up to 10485.76 s; the details of mechanisms and feasibility regarding maximum length of the extended DRX cycles for RRC Inactive and Idle need to be checked by SA2, CT1 and/or RAN4.
   c) RAN2 to decide which Node(s) configure eDRX in RRC_Idle and RRC Inactive.
VII) Specify support for the following RRM measurement relaxations for neighbouring cells for RedCap devices: for RRC_Idle/Inactive/Connected [RAN2, RAN4]:
   a) Specify measurement (RSRP/RSRQ) based stationarity criterion and not-at-cell-edge criterion [RAN2].
      i. Enabling/disabling of RRM measurement relaxation should be under the network's control. Specify both broadcast and dedicated signalling for enabling/disabling of RRM measurement relaxation.
   b) Specify UE requirements for RRM measurement relaxation [RAN4].
   c) No RRM measurement relaxations are specified for the serving cell.
VIII) Specify RAN4 core requirements for the above.

It should be noted that uplink coverage enhancement solutions specified in the NR Coverage Enhancement work item (NR_cov_enh) shall be assumed to be available also to RedCap UEs by default (with small modifications for RedCap UEs if found necessary). Power saving enhancement solutions specified in the UE Power Saving Enhancements work item (NR_UE_pow_sav_enh) shall be assumed to be available also to RedCap UEs by default. Rel-15 SSB bandwidth is reused and L1 changes minimized. The work defined as part of this work item is not to overlap with LPWA use cases. Coexistence with non-RedCap UEs is to be ensured. This work item focuses on SA mode and single connectivity with operation in a single band at a time.

Cell selection and re-selection in RRC IDLE and RRC INACTIVE modes have been described in 3GPP TS 38.300 v. 17.0.0 as follows:
9.2.1 Mobility in RRC_IDLE
9.2.1.1 Cell Selection
The principles of PLMN selection in NR are based on the 3GPP PLMN selection principles. Cell selection is required on transition from RM-DEREGISTERED to RM-REGISTERED, from CM-IDLE to CM-CONNECTED and from CM-CONNECTED to CM-IDLE and is based on the following principles:
   The UE NAS layer identifies a selected PLMN and equivalent PLMNs;
   Cell selection is always based on CD-SSBs located on the synchronization raster (see clause 5.2.4):
      The UE searches the NR frequency bands and for each carrier frequency identifies the strongest cell as per the CD-SSB. It then reads cell system information broadcast to identify its PLMN(s):
         The UE may search each carrier in turn (“initial cell selection”) or make use of stored information to shorten the search (“stored information cell selection”).
   The UE seeks to identify a suitable cell; if it is not able to identify a suitable cell it seeks to identify an acceptable cell. When a suitable cell is found or if only an acceptable cell is found it camps on that cell and commence the cell reselection procedure:
      A suitable cell is one for which the measured cell attributes satisfy the cell selection criteria; the cell PLMN is the selected PLMN, registered or an equivalent PLMN; the cell is not barred or reserved and the cell is not part of a tracking area which is in the list of “forbidden tracking areas for roaming”;
      An acceptable cell is one for which the measured cell attributes satisfy the cell selection criteria and the cell is not barred.
   The IAB-MT applies the cell selection procedure as described for the UE with the following differences:
      The IAB-MT ignores cell-barring or cell-reservation indications contained in cell system information broadcast;
      The IAB-MT only considers a cell as a candidate for cell selection if the cell system information broadcast indicates IAB support for the selected PLMN or the selected SNPN.

### Transition to RRC_IDLE

On transition from RRC_CONNECTED or RRC_INACTIVE to RRC_IDLE, a UE should camp on a cell as result of cell selection according to the frequency assigned by RRC in the state transition message if any.

### Recovery From Out of Coverage

The UE should attempt to find a suitable cell in the manner described for stored information or initial cell selection above. If no suitable cell is found on any frequency or RAT, the UE should attempt to find an acceptable cell.

In multi-beam operations, the cell quality is derived amongst the beams corresponding to the same cell (see clause 9.2.4).

9.2.1.2 Cell Reselection

A UE in RRC_IDLE performs cell reselection. The principles of the procedure are the following:
Cell reselection is always based on CD-SSBs located on the synchronization raster (see clause 5.2.4).
The UE makes measurements of attributes of the serving and neighbour cells to enable the reselection process:
   For the search and measurement of inter-frequency neighbouring cells, only the carrier frequencies need to be indicated.
Cell reselection identifies the cell that the UE should camp on. It is based on cell reselection criteria which involves measurements of the serving and neighbour cells:
   Intra-frequency reselection is based on ranking of cells;
   Inter-frequency reselection is based on absolute priorities where a UE tries to camp on the highest priority frequency available;
   An NCL can be provided by the serving cell to handle specific cases for intra-and inter-frequency neighbouring cells;
   Exclude-lists can be provided to prevent the UE from reselecting to specific intra-and inter-frequency neighbouring cells;
   Allow-lists can be provided to request the UE to reselect to only specific intra-and inter-frequency neighbouring cells;
   Cell reselection can be speed dependent;
   Service specific prioritisation;
   Slice specific cell reselection information can be provided to facilitate the UE to reselect a cell that supports specific slices.

In multi-beam operations, the cell quality is derived amongst the beams corresponding to the same cell (see clause 9.2.4).

9.2.2 Mobility in RRC INACTIVE 9.2.2.2 Cell Reselection

A UE in RRC INACTIVE performs cell reselection. The principles of the procedure are as for the RRC IDLE state (see clause 9.2.1.2).

As mentioned above, better solutions are needed for cell selection and reselection of RedCap terminal devices as well as other similar terminal devices. For example, a parameter redcapAccessAllowed was introduced in SIB4 for NR under InterFreqCarrierFreqInfo-v1700. The parameter redcapAccessAllowed indicates whether RedCap UEs are allowed to access the frequency. However, it is not specified how this information can be utilized by the UE.

According to embodiments of the present disclosure, there is provided a solution for performing cell selection and/or cell reselection of a terminal device in a radio network. Principle and embodiments of the present disclosure will be described in detail below with reference to the accompanying drawings. However, it is to be noted that these embodiments are given to enable the skilled in the art to implement the solution as proposed herein and not intended to limit scope of the present application in any way.

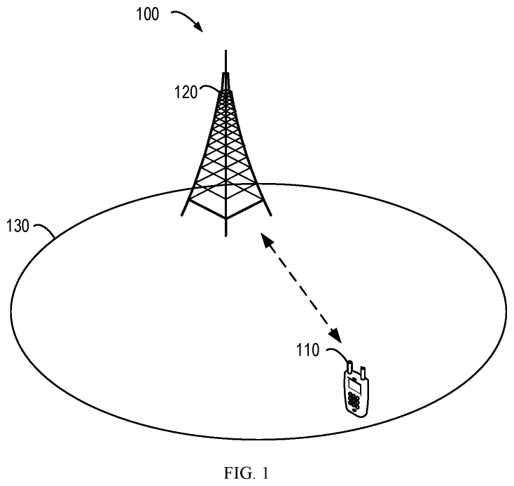

Reference is first made to FIG. 1, which illustrates an example communication system 100 in which embodiments of the present disclosure may be implemented. The system 100, which is a part of a communication network, may include a terminal device 110 and a network device 120. When in an idle state or an inactive state, the terminal device 110 may select a cell to camp on. As shown in FIG. 1, the terminal device 110 may select the cell 130 of the network device 120 and camp on the cell 130. In communication systems, “UL” refers to a communication uplink in a direction from a terminal device to a network device, and “DL” refers to a communication downlink in a direction from the network device to the terminal device.

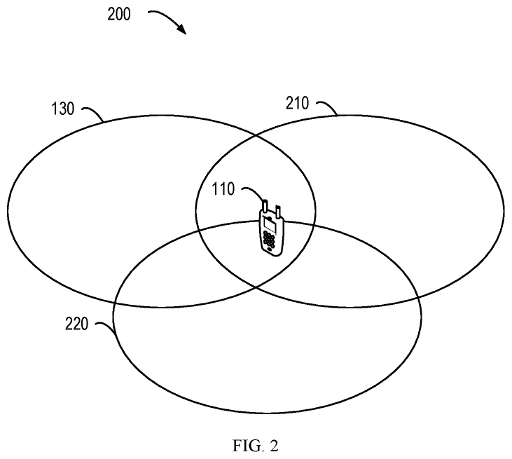

FIG. 2 illustrates an example scenario 200 of cell selection and/or cell reselection of a terminal device 110 in which embodiments of the present disclosure may be implemented. As shown in FIG. 2, the terminal device 110 is located within cells 130, 210 and 220. The cells 130, 210 and 220 may be associated with the same network device or different network devices. The cells 130 (e.g., first cell), 210 (e.g., second cell) and 220 (e.g., third cell) may be neighboring cells, or cells formed in the same geographic area under different frequency coverage. The number of cells is given only for the purpose of illustration without suggesting any limitations. The terminal device 110 may select a cell to camp on. For example, the terminal device 110 may select the cell 130 (e.g., a first cell) of the network device 120 and camp on the cell 130. The terminal device 110 may receive system information of the cell 130 when camping on the cell 130. After camping on the cell 130, the terminal device 110 may continuously performs cell reselection in order to camp on other neighboring cells (e.g., second cell 210 or third cell 220) with higher priority/better channel quality.

It is to be understood that the number of network devices and terminal devices is given only for the purpose of illustration without suggesting any limitations. The system 100 may include any suitable number of network devices and/or terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

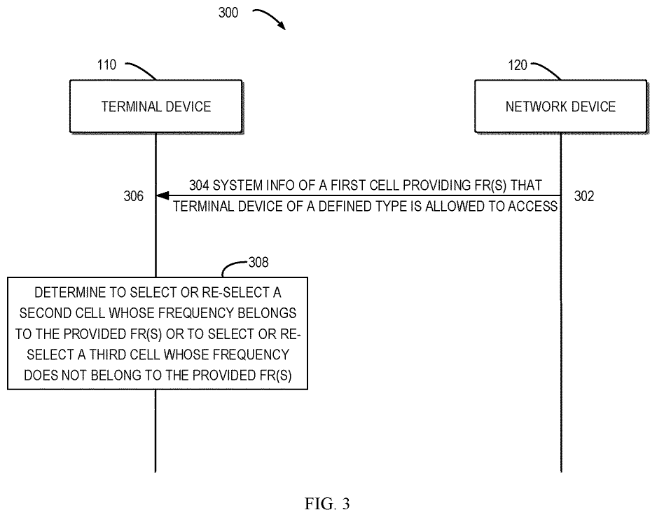

Embodiments of the present disclosure will be described in detail below. Reference is now made to FIG. 3, which shows a signaling chart illustrating process 300 between the terminal device and the network device according to some example embodiments of the present disclosure. Only for the purpose of discussion, the process 300 will be described with reference to FIG. 1. The process 300 may involve the terminal device 110 and the network device 120 in FIG. 1.

In the process 300, the network device 120 transmits 302 system information 304 of a first cell within the radio network to the terminal device 110. The system information 304 provides one or more frequencies (FRS) that a terminal device of a defined type is allowed to access. The terminal device 110 receives 306 the system information 304 in a first cell from the network device 120. The terminal device 110 determines 308, based on at least the system information 304 of the first cell, to select or re-select a second cell within the radio network whose frequency (FR) belongs to the provided one or more frequencies (FRS) or to select or re-select a third cell within the radio network whose frequency does not belong to the provided one or more frequencies (FRS). In this way, the cell selection and reselection for a terminal device of a defined type may be improved.

In some embodiments, the terminal device 110 may determine that the terminal device 110 is of the defined type. In some embodiments, the terminal device of the defined type may include at least first type which may be a fifth generation (5G) reduced capability (REDCAP) user equipment. In some embodiments, the fifth generation (5G) reduced capability (REDCAP) user equipment may comply with a bandwidth criterion which may be either a maximum bandwidth of 20 MHz within a frequency range of 600-6000 MHz, or a maximum bandwidth of 100 MHz within a frequency range of 26-47 GHz. In this way, the cell selection and reselection for a RedCap terminal device may be improved.

In some embodiments, if the terminal device 110 is able to identify the second cell within a time duration, the terminal device 110 may select or re-select the second cell. If the terminal device 110 is unable to identify the second cell within a time duration, the terminal device 110 may select or re-select the third cell. In this way, the cell selection and reselection for a terminal device of a defined type may be more energy efficient and reliable.

In some embodiments, the terminal device 110 may further determine the time duration based on the system information. In some embodiments, the system information may include information of time duration for the terminal device of the defined type to identify the second cell. In this way, the cell selection and reselection for a terminal device of a defined type may be adaptive according to actual needs.

In some embodiments, the time duration may be pre-configured within the terminal device 110. In this way, resource overhead may be reduced. In some embodiments, the terminal device 110 may determine the time duration based on a predefined timer value. Alternatively or additionally, the terminal device 110 may determine the time duration based on a battery level of the terminal device. Alternatively or additionally, the terminal device 110 may determine the time duration based on an overheating condition of the terminal device. Alternatively or additionally, the terminal device 110 may determine the time duration based on whether any cell of the one or more frequencies is detectable. In this way, the cell selection and reselection for a terminal device of a defined type may be more adaptive to actual scenario.

In some embodiments, the terminal device 110 may select or re-select the second cell, or select or re-select the third cell based on reselection priorities configured for the provided one or more frequencies according to the system information. In some embodiments, the reselection priorities configured for the provided one or more frequencies may have higher priorities to select the second cell over the third cell whose frequency does not belong to the provided one or more frequencies. In some embodiments, the system information may include information for the terminal device of the defined type to configure reselection priorities of the one or more frequencies to be higher than reselection priorities of frequencies that do not belong to the one or more frequencies. In some embodiments, the terminal device 110 may determine first reselection priorities of a first frequency of the second cell and a second frequency of the third cell. Based on the first reselection priorities and the system information, the terminal device 110 may determine second reselection priorities of the first frequency and the second frequency such that the second reselection priority of the first frequency is determined to be higher than the second reselection priority of the second frequency regardless of the first reselection priority of the first frequency being lower than the first reselection priority of the second frequency or not. The terminal device 110 may then determine to re-select the second cell or to re-select the third cell based on the second reselection priorities of the first frequency and the second frequency. In this way, reliability for the cell selection and reselection operations may be improved.

In some embodiments, the terminal device 110 may further measure a cell quality on a cell. The terminal device 110 may determine that a frequency of the cell belongs to the provided one or more frequencies. Based on a determination that the frequency of the cell belongs to the provided one or more frequencies, the terminal device 110 may apply an offset value to the measured cell quality for cell selection or re-selection. For example, if the offset is applied for a first cell whose frequency belongs to the one or more frequencies and not applied for a second cell whose frequency does not belong to the one or more frequencies, the offset makes the cell quality measured on the first cell better/worse compared to the measured quality on the second cell. In some embodiments, the offset value may be determined by the terminal device 110 or provided in the system information. In some embodiments, the system information may include information of offset value for the terminal device of the defined type to apply for cell quality of a cell whose frequency belongs to the one or more frequencies. In this way, the chance for the terminal device to select or re-select the provided frequencies may be adjusted according to actual needs.

In some embodiments, the system information may be received via a system information block 4 (SIB4) from the first cell. In this way, reliability for the cell selection and reselection operations may be improved without increasing resource overhead. In some embodiments, the system information may be indicated by a parameter redcapAccessAllowed within the system information block 4 (SIB4 to improve cell selection and reselection operations.

In some embodiments, at least one of the second cell and the third cell may be different from the first cell. In this way, the terminal device 110 may be able to utilize system information of the cell where the UE is camping as well as the system information received from some other cells previously.

There may be various manners for the network device 120 to perform cell selection and reselection operations utilizing the redcapAccessAllowed parameter. In one embodiment, the terminal device 110 may use the redcapAccessAllowed parameter with indication for a frequency for cell selection and re-selection procedures. In one example, the terminal device 110 may skip the frequencies for which the redcapAccessAllowed parameter may not be provided for cell selection and re-selection evaluation. In other words, the terminal device 110 may be allowed to ignore frequencies not provided with the redcapAccessAllowed parameter.

In one example, if no suitable cell can be identified through frequencies for which the redcapAccessAllowed parameter is provided within a time duration, the terminal device 110 may search for a suitable cell from any frequency. In one example, the time duration can be pre-defined in a specification or provided by the network. Alternatively, the time duration can be determined by the UE implementation, e.g., based on a pre-defined timer value, a battery level of the terminal device 110, an overheating condition, whether any cell can be detectable from the given frequencies, etc. In one further example, if another cell providing the redcapAccessAllowed parameter with indication for frequencies is not applied for the cell evaluation, the terminal device 110 may still utilize the redcapAccessAllowed indication for cell selection and reselection and apply the same principle, i.e., skip the frequencies not provided by the redcapAccessAllowed parameter for cell selection and re-selection evaluation.

In one example, a RedCap terminal device (for example, the terminal device 110) may account the cell reselection priorities only for the frequencies for which the redcapAccessAllowed parameter is provided. In other words, the terminal device 110 may not be required to perform cell selection or re-selection evaluation on frequencies for which the redcapAccessAllowed parameter is not indicated.

For example, the RedCap terminal device may consider any frequency for which the redcapAccessAllowed parameter is not provided as having lower cell reselection priority than a frequency for which the redcapAccessAllowed parameter is provided. For example, if frequencies #1, #3, and #4 for which the redcapAccessAllowed parameter is not provided are configured cell reselection priorities of 7, 5, and 4, respectively (a higher value means a higher priority), and frequencies #2, #5, and #6 for which the redcapAccessAllowed parameter is provided are configured with cell reselection priorities of 6, 3, and 3, respectively, a RedCap terminal device may regard frequency #2 as highest priority, and #5 and #6 as second highest priority, and frequencies #1, #3, and #4 in descending order of priority after. In this case the terminal device 110 decides these frequency priorities by itself. In other words, frequency priority handling is not specified or signaled to the terminal device 110.

In one example, the terminal device 110 may apply an offset value into the measured cell quality value in the frequencies for which the redcapAccessAllowed parameter is provided. Offset value can be applied to measured RSRP/RSRQ/RSSI e.g. in dBs or dBMs. By doing this, there is higher opportunity for the terminal device 110 to select the frequencies for which the redcapAccessAllowed parameter is provided compared to other frequencies.

For example, an example implementation may be embodied as follows:
redcapAccessAllowed
Indicates whether RedCap UEs are allowed to access the frequency. If not provided for a frequency in InterFreqCarrierFreqInfo-v1700, RedCap UE shall skip the frequency for the cell re-selection.

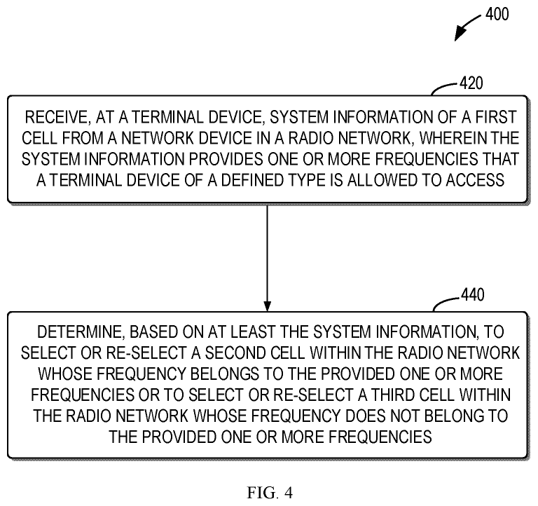

FIG. 4 shows a flowchart of an example method 400 implemented at a terminal device in accordance with some embodiments of the present disclosure. For the purpose of discussion, the method 400 will be described from the perspective of the terminal device 110 with reference to FIG. 1. With the method 400, cell selection and reselection for a terminal device of a defined type may be improved.

At block 420, the terminal device 110 receives system information of a first cell from a network device 120 in a radio network. The system information may provide one or more frequencies that a terminal device of a defined type is allowed to access. At block 420, the terminal device 110 determines, based on at least the system information, to select or re-select a second cell within the radio network whose frequency belongs to the provided one or more frequencies or to select or re-select a third cell within the radio network whose frequency does not belong to the provided one or more frequencies.

In some embodiments, the terminal device 110 may determine that the terminal device 110 is of the defined type. In some embodiments, the terminal device of the defined type may include at least first type which may be a fifth generation (5G) reduced capability (REDCAP) user equipment. In some embodiments, the fifth generation (5G) reduced capability (REDCAP) user equipment may comply with a bandwidth criterion which may be either a maximum bandwidth of 20 MHz within a frequency range of 600-6000 MHz, or a maximum bandwidth of 100 MHz within a frequency range of 26-47 GHz.

In some embodiments, the terminal device 110 may select or re-select the second cell if the terminal device is able to identify the second cell within a time duration and select or re-select the third cell if the terminal device is unable to identify the second cell within a time duration.

In some embodiments, the terminal device 110 may further determine the time duration based on the system information. In some embodiments, the time duration may be pre-configured within the terminal device 110. In some embodiments, the terminal device 110 may determine the time duration based on at least one of: a predefined timer value, a battery level of the terminal device, an overheating condition of the terminal device, or whether any cell of the one or more frequencies is detectable.

In some embodiments, the terminal device 110 may select or re-select the second cell or select or re-select the third cell based on reselection priorities configured for the provided one or more frequencies according to the system information. In some embodiments, the reselection priorities configured for the provided one or more frequencies may have higher priorities to select the second cell over the third cell whose frequency which does not belong to the provided one or more frequencies.

In some embodiments, the terminal device 110 may further determine first reselection priorities of a first frequency of the second cell and a second frequency of the third cell; determine, based on the first reselection priorities and the system information, second reselection priorities of the first frequency and the second frequency such that the second reselection priority of the first frequency is determined to be higher than the second reselection priority of the second frequency regardless of the first reselection priority of the first frequency being lower than the first reselection priority of the second frequency or not; and determine to re-select the second cell or to re-select the third cell based on the second reselection priorities of the first frequency and the second frequency.

In some embodiments, the terminal device 110 may further measure a cell quality on a cell; determine that a frequency of the cell belongs to the provided one or more frequencies; and based on a determination that the frequency of the cell belongs to the provided one or more frequencies, apply an offset value to the measured cell quality for cell selection or re-selection. In some embodiments, the offset value may be determined by the terminal device 110 or provided in the system information.

In some embodiments, the system information may be received via a system information block 4 (SIB4) from the first cell. In some embodiments, the system information may be indicated by a parameter, redcapAccessAllowed, in the system information block 4 (SIB4). In some embodiments, at least one of the second cell and the third cell may be different from the first cell.

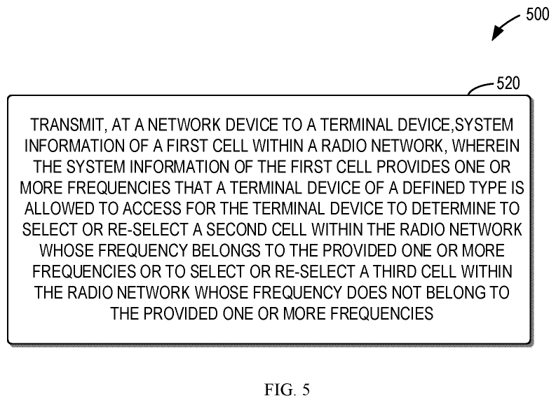

FIG. 5 shows a flowchart of an example method 500 implemented at a network device in accordance with some embodiments of the present disclosure. For the purpose of discussion, the method 500 will be described from the perspective of the network device 120 with reference to FIG. 1. With the method 500, an improved scheme for cell selection and reselection may be supported.

At block 520, the network device 120 transmits, to the terminal device 110, system information of a first cell within a radio network. The system information of the first cell provides one or more frequencies that a terminal device of a defined type is allowed to access for the terminal device 110 to determine to select or re-select a second cell within the radio network whose frequency belongs to the provided one or more frequencies or to select or re-select a third cell within the radio network whose frequency does not belong to the provided one or more frequencies.

In some embodiments, the terminal device of the defined type may include at least first type which may be a fifth generation (5G) reduced capability (REDCAP) user equipment. In some embodiments, the fifth generation (5G) reduced capability (REDCAP) user equipment may comply with a bandwidth criterion which may be either a maximum bandwidth of 20 MHz within a frequency range of 600-6000 MHz, or a maximum bandwidth of 100 MHz within a frequency range of 26-47 GHz.

In some embodiments, the system information may include information of time duration for the terminal device of the defined type to identify the second cell. In some embodiments, the system information may include information for the terminal device of the defined type to configure reselection priorities of the one or more frequencies to be higher than reselection priorities of frequencies that do not belong to the one or more frequencies. In some embodiments, the system information may include information of offset value for the terminal device of the defined type to apply for cell quality of a cell whose frequency belongs to the one or more frequencies.

In some embodiments, when transmitting the system information, the network device 120 may transmit the system information via a system information block 4 (SIB4) of the first cell. In some embodiments, the system information may be indicated by a parameter, redcapAccessAllowed, in the system information block 4 (SIB4). In some embodiments, at least one of the second cell and the third cell may be different from the first cell.

In some embodiments, an apparatus capable of performing any of the method 400 (for example, the terminal device 110) may include means for performing the respective steps of the method 400. The means may be implemented in any suitable form. For example, the means may be implemented in a circuitry or software module.

In some embodiments, the apparatus may include means for receiving, at a terminal device 110, system information of a first cell from a network device in a radio network, wherein the system information provides one or more frequencies that a terminal device of a defined type is allowed to access; and means for determining, based on at least the system information, to select or re-select a second cell within the radio network whose frequency belongs to the provided one or more frequencies or to select or re-select a third cell within the radio network whose frequency does not belong to the provided one or more frequencies.

In some embodiments, the apparatus may further include means for determining that the terminal device is of the defined type. In some embodiments, the terminal device of the defined type may include at least first type which may include a fifth generation (5G) reduced capability (REDCAP) user equipment. In some embodiments, the fifth generation (5G) reduced capability (REDCAP) user equipment may comply with a bandwidth criterion which may include either a maximum bandwidth of 20 MHz within a frequency range of 600-6000 MHz, or a maximum bandwidth of 100 MHz within a frequency range of 26-47 GHz.

In some embodiments, the apparatus may further include means for selecting or re-selecting the second cell if the terminal device is able to identify the second cell within a time duration; and means for selecting or re-selecting the third cell if the terminal device is unable to identify the second cell within a time duration.

In some embodiments, the apparatus may further include means for determining the time duration based on the system information. In some embodiments, the time duration may be pre-configured within the terminal device 110.

In some embodiments, the apparatus may further include means for determining the time duration based on at least one of: a predefined timer value, a battery level of the terminal device, an overheating condition of the terminal device, or whether any cell of the one or more frequencies is detectable.

In some embodiments, the apparatus may further include means for selecting or re-selecting the second cell, or selecting or re-selecting the third cell based on reselection priorities configured for the provided one or more frequencies according to the system information. In some embodiments, the reselection priorities configured for the provided one or more frequencies may have higher priorities to select the second cell over the third cell whose frequency which does not belong to the provided one or more frequencies.

In some embodiments, the apparatus may further include means for determining first reselection priorities of a first frequency of the second cell and a second frequency of the third cell; means for determining, based on the first reselection priorities and the system information, second reselection priorities of the first frequency and the second frequency such that the second reselection priority of the first frequency is determined to be higher than the second reselection priority of the second frequency regardless of the first reselection priority of the first frequency being lower than the first reselection priority of the second frequency or not; and means for determining to re-select the second cell or to re-select the third cell based on the second reselection priorities of the first frequency and the second frequency.

In some embodiments, the apparatus may further include means for measuring a cell quality on a cell; determine that a frequency of the cell belongs to the provided one or more frequencies; and means for applying an offset value to the measured cell quality for cell selection or re-selection based on a determination that the frequency of the cell belongs to the provided one or more frequencies. In some embodiments, the offset value may be determined by the terminal device 110 or provided in the system information.

In some embodiments, the system information may be received via a system information block 4 (SIB4) from the first cell. In some embodiments, the system information may be indicated by a parameter, redcapAccessAllowed, in the system information block 4 (SIB4). In some embodiments, at least one of the second cell and the third cell may be different from the first cell.

In some embodiments, the apparatus further may include means for performing other steps in some embodiments of the method 400. In some embodiments, the means may include at least one processor and at least one memory including computer program code. The at least one memory and computer program code are configured to, with the at least one processor, cause the performance of the apparatus.

In some embodiments, an apparatus capable of performing any of the method 500 (for example, the network device 120) may include means for performing the respective steps of the method 500. The means may be implemented in any suitable form. For example, the means may be implemented in a circuitry or software module.

In some embodiments, the apparatus may include: means for transmitting, at a network device 120 to a terminal device 110, system information of a first cell within a radio network, wherein the system information of the first cell provides one or more frequencies that a terminal device of a defined type is allowed to access for the terminal device to determine to select or re-select a second cell within the radio network whose frequency belongs to the provided one or more frequencies or to select or re-select a third cell within the radio network whose frequency does not belong to the provided one or more frequencies.

In some embodiments, the terminal device of the defined type may include at least first type which may be a fifth generation (5G) reduced capability (REDCAP) user equipment. In some embodiments, the fifth generation (5G) reduced capability (REDCAP) user equipment may comply with a bandwidth criterion which may be either a maximum bandwidth of 20 MHz within a frequency range of 600-6000 MHz, or a maximum bandwidth of 100 MHz within a frequency range of 26-47 GHz.

In some embodiments, the system information may include information of time duration for the terminal device of the defined type to identify the second cell. In some embodiments, the system information may include information for the terminal device of the defined type to configure reselection priorities of the one or more frequencies to be higher than reselection priorities of frequencies that do not belong to the one or more frequencies. In some embodiments, the system information may include information of offset value for the terminal device of the defined type to apply for cell quality of a cell whose frequency belongs to the one or more frequencies.

In some embodiments, means for transmitting the system information may include means for transmitting the system information via a system information block 4 (SIB4) of the first cell. In some embodiments, the system information may be indicated by a parameter, redcapAccessAllowed, in the system information block 4 (SIB4). In some embodiments, at least one of the second cell and the third cell may be different from the first cell In some embodiments, the apparatus further may include means for performing other steps in some embodiments of the method 500. In some embodiments, the means may include at least one processor and at least one memory including computer program code. The at least one memory and computer program code are configured to, with the at least one processor, cause the performance of the apparatus.

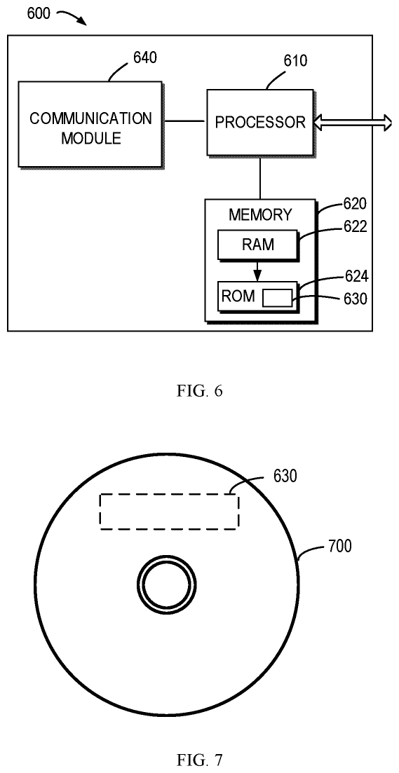

FIG. 6 is a simplified block diagram of a device 600 that is suitable for implementing embodiments of the present disclosure. The device 600 may be provided to implement the communication device, for example the terminal device 110 or the network device 120 as shown in FIG. 1. As shown, the device 600 includes one or more processors 610, one or more memories 620 coupled to the processor 610, and one or more transmitters and/or receivers (TX/RX) 640 coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A terminal device for communication, comprising:
at least one processor; and
at least one memory storing instructions that, when executed by the at least one processor, cause the terminal device at least to:
receive system information of a first cell from a network device in a radio network, wherein the system information provides one or more frequencies that a terminal device of a defined type is allowed to access; and
determine, based on at least the system information, to select or re-select a second cell within the radio network whose frequency belongs to the provided one or more frequencies or to select or re-select a third cell within the radio network whose frequency does not belong to the provided one or more frequencies.

33. The terminal device of claim 32, wherein the terminal device is further caused to perform at least one or more of:
determine that the terminal device is of the defined type;
select or re-select the second cell if the terminal device is able to identify the second cell within a time duration, and select or re-select the third cell if the terminal device is unable to identify the second cell within a time duration.

34. The terminal device of claim 33, wherein the terminal device of the defined type comprises at least a first type which comprises a fifth generation (5G) reduced capability (REDCAP) user equipment.

35. The terminal device of claim 34, wherein the fifth generation (5G) reduced capability (REDCAP) user equipment complies with a bandwidth criterion which comprises either a maximum bandwidth of 20 MHz within a frequency range of 600-6000 MHz, or a maximum bandwidth of 100 MHz within a frequency range of 26-47 GHz.

36. The terminal device of claim 33, wherein the terminal device is further caused to determine the time duration based on one or more of:
the system information;
a predefined timer value;
a battery level of the terminal device;
an overheating condition of the terminal device; or
whether any cell of the one or more frequencies is detectable.

37. The terminal device of claim 33, wherein the time duration is pre-configured within the terminal device.

38. The terminal device of claim 32, wherein the terminal device is caused to select or re-select the second cell, or to select or re-select the third cell based on:
reselection priorities configured for the provided one or more frequencies according to the system information.

39. The terminal device of claim 38, wherein the reselection priorities configured for the provided one or more frequencies have higher priorities to select the second cell over the third cell whose frequency which does not belong to the provided one or more frequencies.

40. The terminal device of claim 39, wherein the terminal device is further caused to:
determine first reselection priorities of a first frequency of the second cell and a second frequency of the third cell;
determine, based on the first reselection priorities and the system information, second reselection priorities of the first frequency and the second frequency such that the second reselection priority of the first frequency is determined to be higher than the second reselection priority of the second frequency regardless of the first reselection priority of the first frequency being lower than the first reselection priority of the second frequency or not; and
determine to re-select the second cell or to re-select the third cell based on the second reselection priorities of the first frequency and the second frequency.

41. The terminal device of claim 32, wherein the terminal device is further caused to:
measure a cell quality on a cell;
determine that a frequency of the cell belongs to the provided one or more frequencies; and
based on a determination that the frequency of the cell belongs to the provided one or more frequencies, apply an offset value to the measured cell quality for cell selection or re-selection.

42. The terminal device of claim 41, wherein the offset value is determined by the terminal device or provided in the system information.

43. The terminal device of claim 32, wherein the system information being one or both of:
received via a system information block 4 (SIB4) from the first cell; or
indicated by a parameter, redcapAccessAllowed, in the system information block 4 (SIB4).

44. The terminal device of claim 32, wherein at least one of the second cell and the third cell is different from the first cell.

45. A network device for communication, comprising:
at least one processor; and
at least one memory storing instructions that, when executed by the at least one processor, cause the network device at least to:
transmit, to a terminal device, system information of a first cell within a radio network, wherein the system information of the first cell provides one or more frequencies that a terminal device of a defined type is allowed to access in order for the terminal device to determine to select or re-select a second cell within the radio network whose frequency belongs to the provided one or more frequencies or to select or re-select a third cell within the radio network whose frequency does not belong to the provided one or more frequencies.

46. The network device of claim 45, wherein the system information comprises information of time duration for the terminal device of the defined type to identify the second cell.

47. The network device of claim 45, wherein the system information comprises information for the terminal device of the defined type to configure reselection priorities of the one or more frequencies to be higher than reselection priorities of frequencies that do not belong to the one or more frequencies.

48. The network device of claim 45, wherein the system information comprises information of offset value for the terminal device of the defined type to apply for cell quality of a cell whose frequency belongs to the one or more frequencies.

49. The network device of claim 45, wherein at least one of the second cell and the third cell is different from the first cell.

50. A method for communication, comprising:
receiving, at a terminal device, system information of a first cell from a network device in a radio network, wherein the system information provides one or more frequencies that a terminal device of a defined type is allowed to access; and
determining, based on at least the system information, to select or re-select a second cell within the radio network whose frequency belongs to the provided one or more frequencies or to select or re-select a third cell within the radio network whose frequency does not belong to the provided one or more frequencies.
